(19) United States
(12) Patent Application Publication
(10) Pub. No.: US 2004/0243452 A1
(43) Pub. Date: Dec. 2, 2004

(54) Method and system for proactive shipment delivery

(76) Inventors: Jacqueline Barton, Austin, TX (US); Monica L. Carson, Round Rock, TX (US); Tracy A. Masson, Austin, TX (US)

Correspondence Address: HAMILTON & TERRILE, LLP, P.O. BOX 203518, AUSTIN, TX, 78720, US

(21) Appl. No.: 10/447,589

(22) Filed: May 29, 2003

(51) Int. Cl. G06F 17/60

(52) U.S. Cl. 705/7

(57) ABSTRACT

Delivery of build-to-order information handling system shipments is managed by a shipment alert engine that compares actual shipment delivery path information derived from a delivery provider's Electronic Data Interchange (EDI) scans with a delivery path projected from a shipment's service level and delivery location to identify shipments having an increased likelihood of being wrong, missing or damaged before the expected delivery time to a customer. For instance, a service module identifies a shipment as missing or lost in the absence of an EDI scan for a time period related to the time allowed for delivery at a shipment's service level. As another example, a geographic module identifies a shipment as missing or lost if the location of an EDI scan places the shipment outside of a projected shipment delivery path. An exception module identifies shipments for inspection due to indicated damage.

### BACKGROUND OF THE INVENTION

1. Field of the Invention

The present invention relates in general to the field of proactive shipment delivery, and more particularly to a method and system for proactively managing shipment of information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the diverse functions that are performed by information handling systems, businesses and individuals have come to rely on build-to-order manufacturers that build and ship information handling systems to customer specifications. A customer places an order for an information handling system having a desired hardware and software configuration and specifies a location for delivery of the information handling system. The manufacturer builds the information handling system to the customer's order, typically over a period of days, and then ships the information handling system to the delivery location specified by the customer, generally at a service level specified by the customer, such as overnight delivery, two-day delivery, three-day delivery or three to five day delivery. Build-to-order manufacture of information handling systems succeeds in providing a customer with a desired configuration in an efficient and cost effective manner with a minimal delay introduced by the delivery process which is typically provided by shipment delivery providers, such as UPS or FedEx.

One difficulty with the build-to-order manufacture of information handling systems is that problems related to the manufacture and delivery of an information handling system often are not identified until a customer complains. For instance, a customer who has an information handling system shipment that is late, missing, or wrong generally must call into a customer service center of the manufacturer to report the difficulty before the manufacturer knows of the difficulty or takes action to correct the problem. Typically, if an information handling system is damaged enroute to a customer, the shipment delivery provider still delivers the information handling system and reports the damage to the manufacturer only if the customer refuses the shipment. Similarly, customers who receive the wrong shipment or an incorrectly configured information handling system generally refuse delivery and complain to the manufacturer to have a replacement sent. Often, unnecessary exchange systems are shipped due to confusion that results from customer complaints due to an overdue delivery or delivery of a shipment with an incorrect configuration or a correct configuration that the customer perceives to be incorrect. The involvement of customers in correcting delivery errors, such as wrong, missing or damaged shipments, creates a negative customer experience. Indeed, approximately half of exchanges are related to perceived loss due to late, mis-sorted, mis-routed, bad address or failed EDI transmissions. Additional delays introduced by the manufacture and delivery of replacement information handling systems reinforces a negative customer experience.

### SUMMARY OF THE INVENTION

Therefore a need has arisen for a method and system which allows a manufacturer to proactively identify and manage shipment delivery errors, such as wrong, missing or damaged information handling system shipments.

In accordance with the present invention, a method and system are provided which substantially reduce the disadvantages and problems associated with previous methods and systems for management of shipment deliveries. A shipment alert engine compares shipment delivery instructions with shipment delivery provider updates to identify shipment discrepancies before a shipment's expected delivery time, such as wrong, missing or damaged shipments.

More specifically, build-to-order information handling systems are manufactured and packaged for delivery as shipments to customers by a delivery service provider. Shipment delivery instructions direct the delivery service provider to deliver each shipment to a delivery location at a delivery service level, such as overnight delivery, two-day delivery or three to five day delivery. Shipment movement by the delivery service provider along a delivery path is monitored with scans of an identifier associated with each shipment and the scanned delivery updates are communicated to a shipment alert engine associated with the manufacturer of the information handling system. A projected path modeling module generates a delivery table having a projected delivery path for each shipment determined from the shipment delivery instructions and an actual delivery path determined from shipment updates scanned by the delivery provider. A service sensitive module issues an alert if a comparison of the projected and actual delivery paths indicates a likelihood that the shipment will not be delivered in the time period provided by the service level, such as a failure to scan a shipment at a projected time indicating a missing shipment. A geographic sensitive module issues an alert if a comparison of the projected and actual delivery paths indicate a likelihood that the shipment has been misdirected, such as a scan indicating a shipment location not in the projected delivery path. An exception based module issues an alert if an exception, such as a damage code, is scanned for a shipment. The manufacturer selects alerts to proactively correct shipment discrepancies before expected delivery to the customer, or by taking action to change or redirect the delivery to correct the discrepancy, or initiating manufacture and/or shipment of an exchange for the customer.

The present invention provides a number of important technical advantages. One example of an important technical advantage is that information handling system shipment delivery errors, such as wrong, missing or damaged shipments, are proactively identified and corrected before expected shipment delivery to reduce customer complaints and negative customer experiences. Proactive discovery and correction of potential customer shipment delivery complaints reduces call volume to the manufacturer resulting in decreased expense to man call centers and reduced call wait times. Further, proactive discovery and correction of shipment delivery errors before a customer expects delivery reduces customer involvement in corrective action and thus reduces the likelihood of unnecessary exchange system manufacture and delivery.

### BRIEF DESCRIPTION OF THE DRAWINGS

The present invention may be better understood, and its numerous objects, features and advantages made apparent to those skilled in the art by referencing the accompanying drawing.

FIG. 1 depicts a block diagram of a system for management by a manufacturer of delivery of information handling system shipments.

### DETAILED DESCRIPTION

Deliveries of information handling system shipments are proactively managed by a manufacturer through comparison of projected delivery paths inferred from shipment instructions and actual delivery paths inferred from delivery provider shipment scans so that shipment discrepancies, such as wrong, missing or damaged shipments, are identified before expected delivery to a customer of an information handling system shipment. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

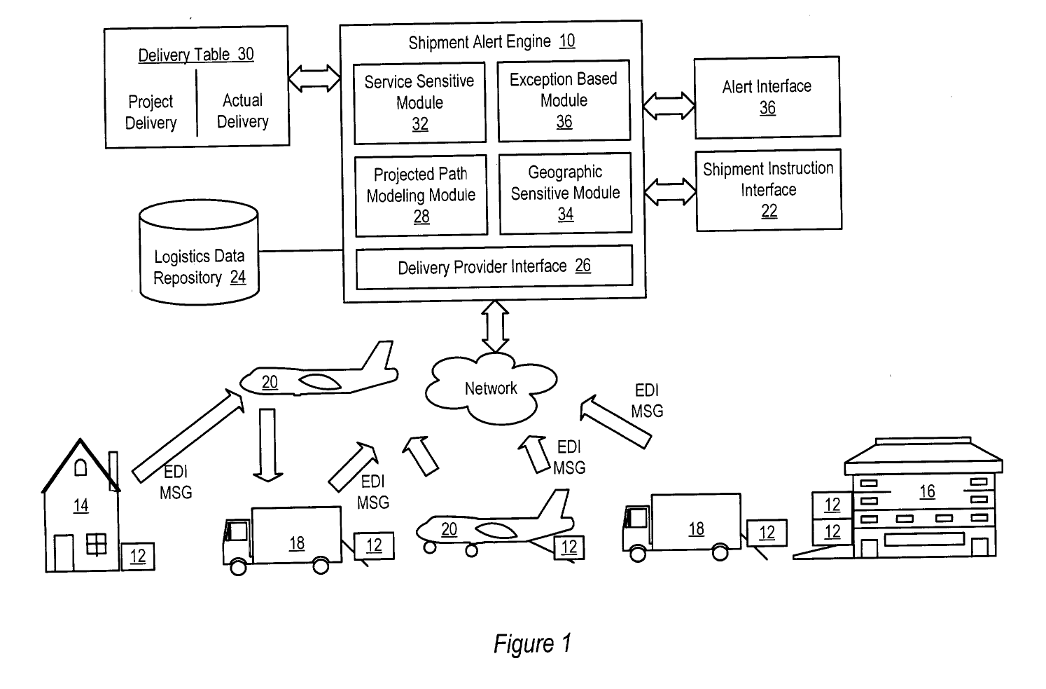

Referring now to FIG. 1, a block diagram depicts a shipment alert engine 10 that coordinates management by an information handling system manufacturer of delivery of shipments 12 to customer locations 14 from a manufacturing location 16. Build-to-order information handling systems are manufactured and packaged as shipments 12 at manufacturing location 16 with each shipment having a scanable identifier tag, such as a bar code bearing a unique identifier for the information handling system. Shipment delivery instructions are provided to the shipment delivery provider for delivery of each shipment to a desired location. For instance, shipment delivery instructions include a physical address for delivery of the information handling system and a service level for delivery, such as next day, two day, three day or three to five day delivery. The shipment delivery provider routes the shipments through logistics hubs with trucks 18 and airplanes 20 and periodically scans the identifier tag to track the delivery path of each shipment. For instance, location and time codes for each shipment scan are sent as Electronic Data Interchange (EDI) updates to a control network of the manufacturer with information providing delivery status scans until shipment is at a customer destination and delivered free and clear.

Shipment alert engine 10 tracks delivery provider shipment updates, such as with EDI 214 and 240 transmissions, to identify discrepancy shipments before the expected delivery of a shipment to its destination. A shipment instruction interface 22 communicates shipment instructions associated with each shipment to shipment alert engine 10 for storage in logistics data repository 24. A delivery provider interface 26 communicates shipment updates from the delivery provider scans to shipment alert engine 10 for storage in logistics data repository 24 and in delivery table 30 as actual delivery path information. A projected path modeling module 28 applies the historical data stored in logistics data repository 24 to develop a projected delivery path for storage in delivery table 30. The projected path modeling module determines likely delivery paths for shipments based on the shipment instructions and other predictive factors, such as time and location of manufacture, size of shipment, weather, and the volume of shipments being handled by the delivery provider. For instance, the projected delivery path defines the locations and times at which shipment update scans should occur for an on time shipment delivery.

Shipment alert engine 10 includes business rule modules that compare the projected and actual delivery path information of delivery table 30 to identify discrepancy shipments that have an increased likelihood of reaching a wrong, missing or damaged status before the expected delivery of the shipments to their respective destinations. If a discrepancy shipment is identified, an alert is issued at alert interface 36 so that the information handling system manufacturer can proactively handle the discrepancy before involvement of a customer results in a negative customer experience. For instance, if a shipment alert issued that indicates that a shipment is missing, the manufacturer can expedite the sending of a replacement to the customer to ensure delivery before the expected delivery of the original shipment, or shortly thereafter, without the need for the customer to call the manufacture and complain. Similarly, if a wrong or damaged shipment alert is issued, the manufacture can take proactive steps to re-direct wayward shipments or send exchange systems. For instance, if an alert issue indicates damage to an information handling system, the manufacturer can obtain electronic images of the damage, such as a photo or video sent to the manufacturer to determine whether the system should be delivered or replaced.

A service sensitive module 32 identifies discrepant shipments having a likelihood of violating the service level associated with a shipment, such as a delivery that occurs after the delivery service level selected by a customer. In one embodiment, service sensitive module 32 issues alerts for shipments that have not had a scan update in a time period related to the service level of the shipment. For instance, if a next day shipment does not have a scan update for a twelve hour period, a service level alert is issued for that shipment; if a two day shipment does not have a scan update for a twenty-four hour period, a service level alert is issued for that shipment; and if a scan update does occur for forty-eight hours with a shipment having a three day or greater service level, a service alert is issued for that shipment. Alternatively, service sensitive module 32 analyzes shipment updates to determine the probability that shipment will violate its service level and issues a service level alert if the probability exceeds a predetermined threshold. Geographic sensitive module 34 compares the location of each shipment update with projected delivery path locations and issues a geographic alert if the actual location falls within a projected location that indicates misrouting of the shipment. For instance, a shipment from Texas to New York that is projected to pass through a hub in Tennessee will result in a geographic alert if an update scan includes a location code for a hub in Utah or another location with an increased probability of a misrouting discrepancy. The geographic alert issues regardless of the service level and remaining delivery time so that the manufacturer can intervene to redirect the shipment or initiate the sending or an exchange. Exception based module 36 issues an alert if an exception code, such as a damage code, is detected in a shipment update. An exception alert allows the manufacturer to initiate an inspection of the shipment, such as with transmission of electronic images of the damage to the manufacturer, to determine whether to attempt delivery of the shipment or issue an exchange.

Although the present invention has been described in detail, it should be understood that various changes, substitutions and alterations can be made hereto without departing from the spirit and scope of the invention as defined by the appended claims.

What is claimed is:

1. An information handling system shipment delivery system comprising:
a shipment interface operable to accept instructions for delivery of information handling systems to customers at expected delivery times;
a delivery provider interface operable to accept delivery provider shipment updates;
a shipment alert engine operable to compare the shipment delivery instructions and the shipment updates to identify shipments having a shipment discrepancy before the expected delivery times associated with the shipments; and
an alert interface operable to present the discrepancy shipments to the manufacturer of the information handling systems.

2. The system of claim 2 wherein the shipment delivery instructions comprise service level associated with each shipment that defines the amount of time for delivery of the shipment, and wherein the shipment alert engine comprises a service level module operable to compare a predicted shipment delivery computed from the delivery provider shipment updates with a desired shipment delivery based on the service level to identify shipments having a predetermined likelihood of a becoming a late or missing shipment as discrepancy shipments.

3. The system of claim 2 wherein the delivery provider shipment updates comprise a lack of a scan of the shipment for a predetermined time.

4. The system of claim 3 wherein the lack of scan predetermined time comprises approximately one-half of the service level time allowed for shipment delivery.

5. The system of claim 1 wherein the shipment delivery instructions comprise a delivery location associated with each shipment, and wherein the shipment alert engine comprises a geographic module operable to compare the shipment locations derived from shipment delivery provider updates with locations of a projected shipment path to identify shipments having a predetermined likelihood of becoming a late or missing shipment as discrepancy shipments.

6. The system of claim 5 wherein the geographic module identifies a shipment as a discrepancy if a shipment update having a location scan of the shipment indicates that the shipment has departed from the projected shipment path.

7. The system of claim 5 wherein the geographic module identifies a shipment as a discrepancy if a shipment update having a location scan of the shipment indicates that the shipment has lagged its projected shipment path.

8. The system of claim 1 wherein the shipment delivery provider update comprises an exception update, and wherein the shipment alert engine comprises an exception module operable to coordinate a manufacturer inspection of the information handling system.

9. The system of claim 1 wherein the shipment delivery provider update comprises an Electronic Data Interchange scan.

10. A method for proactive manufacturer management of delivery of shipments by a shipment delivery provider, the method comprising:
associating the shipments with delivery instructions having expected delivery times and delivery locations;
labeling the shipments with identifiers operable for scanning by the delivery provider;
projecting a delivery path for each shipment at the manufacturer;
scanning each shipment during delivery to determine actual delivery path information;
communicating the actual delivery path information to the manufacturer; and
comparing the projected delivery path with the actual delivery path information to identify discrepancy shipments before the expected delivery time.

11. The method of claim 10 wherein the shipments comprise information handling systems.

12. The method of claim 11 wherein:
the delivery instructions comprise a service level having an associated delivery time period; and
comparing the projected delivery path with the actual delivery path further comprises determining a discrepancy shipment in the absence of a shipment scan for a time period proportional to the service level delivery time period.

13. The method of claim 12 wherein the service level comprises next day delivery and the discrepancy shipment determination comprises the absence of a shipment scan for 12 hours.

14. The method of claim 11 wherein comparing the projected delivery path with the actual delivery path further comprises:
comparing the scanned location of a shipment with projected locations of the shipment; and
determining a discrepancy shipment if a the scanned location indicates a predetermined likelihood that the shipment is misdirected.

15. The method of claim 11 wherein comparing the projected delivery path with the actual delivery path further comprises:
identifying an exception code associated with a shipment scan; and
inspecting the shipment to determine whether to deliver the shipment or an exchange.

16. The method of claim 15 wherein inspecting the shipment further comprises communicating an image of the shipment to the manufacturer.

17. The method of claim 11 wherein scanning each shipment comprises performing an Electronic Data Interchange 214 scan.

18. The method of claim 11 wherein scanning each shipment comprises performing an Electronic Data Interchange 240 scan.

19. A system for proactive shipment delivery management by a manufacturer of build-to-order shipments delivered by a delivery provider, the system comprising:
a shipment alert engine operable to:
project delivery paths for the shipments based upon delivery service levels and delivery locations of the shipments, each delivery service level having an associated delivery time;
receive delivery provider scans of shipments, the scans having intermediate shipment locations at identified times during delivery of the shipments;
issue a service alert if the received delivery provider scans indicate a predetermined likelihood that a shipment will not be delivered within the service level delivery time; and
issue a service alert if the received delivery provider scan locations indicate a predetermined likelihood that a shipment is misdirected.

20. The system of claim 19 wherein the shipments comprise build-to-order information handling systems.
